(19) United States
(12) Patent Application Publication
(10) Pub. No.: US 2008/0182175 A1
(43) Pub. Date: Jul. 31, 2008

(54) NON-AQUEOUS ELECTROLYTE SECONDARY CELL

(75) Inventors: Yasunori OKAZAKI, Osaka (JP); Hiromitsu SUWA, Osaka (JP); Masanori OGI, Osaka (JP); Kazuki HAMASAKI, Osaka (JP); Shuichi YAMASHITA, Osaka (JP); Kazuo TOMIMOTO, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/022,472

(22) Filed: Jan. 30, 2008

(30) Foreign Application Priority Data
Jan. 31, 2007 (JP) 2007-021929

(51) Int. Cl. H01M 10/40

(52) U.S. Cl. 429/330; 429/324

(57) ABSTRACT

A non-aqueous electrolyte secondary cell superior in safety against overcharge and in high-temperature cycle characteristic is provided. The non-aqueous electrolyte secondary cell includes a positive electrode, a negative electrode, a non-aqueous electrolyte, and a pressure sensitive safety mechanism that is actuated upon increase in the cell internal pressure. The positive electrode contains lithium carbonate at 0.5 to 1.5 mass %. The non-aqueous electrolyte contains a cycloalkyl benzene compound and/or a compound having a benzene ring and a quaternary carbon adjacent to the benzene ring, the compound or compounds being contained at 0.5 to 2 mass % in total.

### BACKGROUND OF THE INVENTION

1) Field of the Invention

The present invention relates to technology for improvement in overcharge safety and high-temperature cycle characteristic of non-aqueous electrolyte secondary cells.

2) Description of the Related Art

In recent years, there have been rapid enhancement of functionality and rapid reduction in size and weight of mobile information terminals such as mobile phones and laptop computers. As power sources for these terminals, non-aqueous electrolyte secondary cells are widely used for their high energy density and high capacity.

Because the non-aqueous electrolyte secondary cells contain organic solvents, which are flammable, it is necessary to secure safety in case of abnormalities including overcharge of the cell.

To enhance the overcharge safety of the non-aqueous electrolyte secondary cells, Japanese Patent Application Publication No. 4-329268 (patent document 1) suggests incorporating in the cell current cutoff means that is actuated by a rise in the internal pressure of the cell, and adding lithium carbonate to the cell.

Here the lithium carbonate is decomposed at an early stage of overcharge and generates gas, which causes earlier actuation of the current cutoff means to prevent further development of overcharge. Thus, this technique is claimed to drastically enhance overcharge safety. However, the addition of lithium carbonate poses the problem of degraded high-temperature cycle characteristic.

Japanese Patent Application Publication Nos. 2006-236725 (patent document 2), 2004-6260 (patent document 3), and 2001-15155 (patent document 4) suggest adding aromatic compounds to the non-aqueous electrolyte secondary cells.

Patent document 2 discloses adding to the non-aqueous electrolyte at least one aromatic compound selected from the group consisting of a toluene derivative, an anisole derivative, biphenyl, cyclohexyl benzene, tert-butyl benzene, tert-amyl benzene, and diphenyl ether. This technique is claimed to provide a non-aqueous electrolyte secondary cell providing high pressure and having a superior charge-discharge cycle characteristic.

Patent document 3 discloses adding to the non-aqueous electrolyte a compound having an alkyl group bonded to the benzene ring of cyclohexyl benzene, isopropyl benzene, n-butyl benzene, octyl benzene, toluene, xylene, or the like, a halogenated product of any of the foregoing, a compound having a plurality of mutually bonded benzenes such as biphenyl and triphenyl, a halogenated product of any of the foregoing, and a halogenated product of a benzene such as fluorobenzene and chlorobenzene, and adding to the negative electrode a carbonate such as lithium carbonate. This technique is claimed to enhance energy density and safety against overcharge. However, the lithium carbonate contained in the negative electrode fails to work for prevention of overcharge.

Patent document 4 discloses adding to the non-aqueous electrolyte an alkyl benzene derivative or a cycloalkyl benzene derivative having a tertiary carbon adjacent to the phenyl group. This technique is claimed to secure overcharge safety without adversely affecting cell characteristics such as low-temperature characteristic and preservation characteristic.

### SUMMARY OF THE INVENTION

It is an object of the present invention to provide a non-aqueous electrolyte secondary cell having high safety against overcharge and a superior high-temperature characteristic.

In order to accomplish the above-mentioned object, a non-aqueous electrolyte secondary cell according to the present invention includes: a positive electrode having a positive mix having a positive electrode active material capable of intercalating and deintercalating lithium; a negative electrode having a negative electrode active material capable of intercalating and deintercalating lithium; and a non-aqueous electrolyte, wherein: the positive mix contains lithium carbonate at 0.5 to 1.5 mass % relative to 100 for the total mass of the positive mix; and the non-aqueous electrolyte contains a cycloalkyl benzene compound and/or a compound having a benzene ring and a quaternary carbon adjacent to the benzene ring, the compound or compounds being contained at 0.5 to 2.0 mass % in total relative to 100 for the total mass of the non-aqueous electrolyte.

In this configuration, specifying lithium carbonate in the positive mix is specified to 0.5 to 1.5 mass % inhibits degradation of high-temperature discharge characteristic caused by addition of lithium carbonate. By addition of a cycloalkyl benzene compound and/or a compound having a benzene ring and a quaternary carbon adjacent to the benzene ring, degradation of high-temperature discharge characteristic caused by addition of lithium carbonate is further inhibited.

The non-aqueous electrolyte secondary cell of this configuration may further include a pressure sensitive safety mechanism.

With this configuration, the lithium carbonate contained in the positive electrode is decomposed at an early stage of overcharge and generates gas, which causes earlier actuation of the pressure sensitive safety mechanism to prevent further development of overcharge, resulting in drastic improvement in safety against overcharge. Also the high-temperature cycle characteristic is drastically improved by addition of the cycloalkyl benzene compound and/or the compound having a benzene ring and a quaternary carbon adjacent to the benzene ring.

If the lithium carbonate is less than 0.5 mass % in the positive mix, the amount of gas generated by the decomposition of the lithium carbonate is not sufficient, and the pressure sensitive safety mechanism is not actuated at an early stage of overcharge, thereby allowing development of overcharge. Because lithium carbonate itself is not a contributory substance to charge and discharge, addition of it in excess of 1.5 mass % inhibits the charge/discharge reactions, resulting in degradation of charge/discharge characteristics. Thus, the lithium carbonate is preferably specified within the above range.

If the cycloalkyl benzene compound and/or the compound having a benzene ring and a quaternary carbon adjacent to the benzene ring is less than 0.5 mass % in the non-aqueous electrolyte, the high-temperature characteristic cannot be improved sufficiently. If the cycloalkyl benzene compound and/or the compound having a benzene ring and a quaternary carbon adjacent to the benzene ring is in excess of 2 mass %, the charge/discharge characteristics are degraded by the compound or compounds. Thus, the additive or additives may be specified within the above range.

The pressure sensitive safety mechanism, as used herein, is a term encompassing all safety mechanisms, return type or non-return type, that, upon increase in internal cell pressure, cut off current or release gas out of the cell.

Examples of the cycloalkyl benzene compound include cyclohexyl benzene, cyclopentyl benzene, and methylcyclohexyl benzene, among which cyclohexyl benzene is most preferred.

Examples of the compound having a benzene ring and a quaternary carbon adjacent to the benzene ring include tert-amyl benzene, tert-butyl benzene, and tert-hexyl benzene, among which tert-amyl benzene is most preferred.

The non-aqueous electrolyte may further contain vinylene carbonate at 0.1 to 5 mass %. Vinylene carbonate reacts with the negative electrode to form a stable coating film to provide the preferable effect of inhibiting the reaction between the negative electrode and the non-aqueous electrolyte.

Thus, the present invention realizes a non-aqueous electrolyte secondary cell that is superior in safety against overcharge and high-temperature characteristic.

### DESCRIPTION OF THE PREFERRED EMBODIMENTS

The advantageous effects obtained by adding lithium carbonate to the positive electrode will be described on the basis of experimental examples 1 to 6. Then the preferred embodiments of the present invention will be described on the basis of examples. The experimental examples differ from the examples in that the experimental examples do not contain the cycloalkyl benzene compound and/or the compound having a benzene ring and a quaternary carbon adjacent to the benzene ring in the non-aqueous electrolyte.

### EXPERIMENTAL EXAMPLES

### Experimental Example 1

### Preparation of the Positive Electrode

Lithium carbonate and a coprecipitated hydroxide represented by Ni_{0.33}Co_{0.34}Mn_{0.33}(OH)₂ were mixed together and baked in an air atmosphere at 1000° C. for 20 hours, thus obtaining lithium nickel-cobalt-manganese oxide (LiNi_{0.03}Co_{0.34}Mn_{0.33}O₂). Also spinel-type lithium manganese oxide (LiMn2O₄) was obtained by a known method.

Ninety three mass parts of a positive electrode active material made of the spinel-type lithium manganese oxide and the lithium nickel-cobalt-manganese oxide mixed at the ratio of 4:6, 3.0 mass parts of a conducting agent made of acetylene black, 3.0 mass parts of a binding agent made of polyvinylidene fluoride, one mass part of lithium carbonate, and N-Methyl-Pyrrolidone were mixed together, thus preparing a positive electrode active material slurry. The positive electrode active material slurry was applied to both surfaces of a positive electrode current collector made of an aluminum foil of 20 μm thick, and then dried and rolled, thus obtaining a positive electrode plate.

The positive electrode plate is of the structure that has the positive electrode current collector having attached thereto the solid components remaining after removing the solvent (N-Methyl-Pyrrolidone) out of the positive electrode active material slurry by the drying. In this specification, the solid components will be collectively referred to as positive mix.

(Preparation of the Negative Electrode)

A negative electrode active material made of graphite, a thickening agent made of carboxymethylcellulose, a binding agent made of butylene butadiene rubber, and water were mixed together, thus preparing a negative electrode active material slurry. The negative electrode active material slurry was applied to both surfaces of a negative electrode core made of a copper foil of 12 μm thick, and then dried and rolled, thus obtaining a negative electrode plate.

(Preparation of the Electrode Assembly)

The positive electrode plate and the negative electrode plate were superposed onto one another with a polyethylene porous film disposed between the plates, thus preparing an electrode assembly.

(Preparation of the Non-Aqueous Electrolyte)

Fifteen volume parts of ethylene carbonate, 10 volume parts of propylene carbonate, 65 volume parts of dimethyl carbonate, and 10 volume parts of ethyl methyl carbonate were mixed together (at 1 atm and 25° C.), and then LiPF₆ was dissolved therein at a rate of 1.0 mol/liter, thus obtaining an electrolytic solution. To 98 mass parts of this electrolytic solution, 2.0 mass parts of vinylene carbonate was added, thus obtaining a non-aqueous electrolyte.

(Assembly of the Cell)

The electrode assembly was inserted into a cell casing, into which the non-aqueous electrolyte was then injected. The opening of the cell casing was sealed, thus preparing a cylindrical non-aqueous electrolyte secondary cell according to experimental example 1 having a theoretical capacity of 1200 mAh, a diameter of 18 mm, and a height of 65 mm. The cell incorporates a pressure sensitive safety mechanism that cuts off current upon increase in the cell internal pressure.

### Experimental Example 2

A non-aqueous electrolyte secondary cell according to experimental example 2 was prepared in the same manner as in experimental example 1 except that the positive electrode active material was 94 mass parts and lithium carbonate was 0 mass parts.

### Experimental Example 3

A non-aqueous electrolyte secondary cell according to experimental example 3 was prepared in the same manner as in experimental example 1 except that the positive electrode active material was 93.7 mass parts and lithium carbonate was 0.3 mass parts.

### Experimental Example 4

A non-aqueous electrolyte secondary cell according to experimental example 4 was prepared in the same manner as in experimental example 1 except that the positive electrode active material was 93.5 mass parts and lithium carbonate was 0.5 mass parts.

### Experimental Example 5

A non-aqueous electrolyte secondary cell according to experimental example 5 was prepared in the same manner as in experimental example 1 except that the positive electrode active material was 92.5 mass parts and lithium carbonate was 1.5 mass parts.

### Experimental Example 6

A non-aqueous electrolyte secondary cell according to experimental example 6 was prepared in the same manner as in experimental example 1 except that the positive electrode active material was 92 mass parts and lithium carbonate was 2.0 mass parts.

[Overcharge Safety Test]

The cells according to experimental examples 1 to 6 were charged at a constant current of 1200 mA to a voltage of 4.2 V, then at a constant voltage of 4.2 V to a current of 60 mA (25° C.). Then each cell was overcharged at a constant current of 3.0 A. The case that involved smoking and/or firing was estimated NG, and the case without smoking and firing by actuation of the pressure sensitive safety mechanism was estimated OK. The results are shown in Table 1.

[High Rate Discharge Test]

The cells according to experimental examples 1 to 6 were charged at a constant current of 1 It (1200 mA) to a voltage of 4.2 V, then at a constant voltage of 4.2 V to a current of 60 mA (25° C.). Each cell was discharged at a current of 1 It (1200 mA) to a voltage of 2.5 V to measure the discharge capacity of each cell (25° C.). Then each cell was charged under the above-specified conditions and discharged at a current of 20 A (16.67 It) to a voltage of 2.5 V to measure the discharge capacity of each cell. Then the high rate discharge characteristic of each cell was calculated from the following formula. The results are shown in Table 1.

High Rate Discharge Characteristic (%)=20 A Discharge Capacity/1 It Discharge Capacity×100

TABLE 1

| | Lithium | | |
|---|---|---|---|
| | carbonate | Overcharge | |
| | content | test | High rate discharge |
| | (mass %) | result | characteristic (%) |
| Experimental Example 2 | 0.0 | NG | 100.6 |
| Experimental Example 3 | 0.3 | NG | — |
| Experimental Example 4 | 0.5 | OK | 99.8 |
| Experimental Example 1 | 1.0 | OK | 99.6 |
| Experimental Example 5 | 1.5 | OK | 99.1 |
| Experimental Example 6 | 2.0 | OK | 80.6 |

Table 1 shows that experimental examples 2 and 3, which contain equal to or less than 0.3 mass % of lithium carbonate, are estimated NG in the overcharge test, while experimental examples 1 and 4 to 6, which contain equal to or more than 0.5 mass % of lithium carbonate, are estimated OK in the overcharge test.

A possible explanation for the results is as follows. The lithium carbonate is decomposed at an early stage of overcharge and generates gas, which causes early actuation of the pressure sensitive safety mechanism. This explains why experimental examples 1 and 4 to 6, which contain equal to or more than 0.5 mass % of lithium carbonate, are estimated OK in the overcharge test. If the lithium carbonate content is less than 0.5 mass %, the amount of gas generated by the decomposition of the lithium carbonate is not sufficient, and the pressure sensitive safety mechanism is not actuated at an early stage of overcharge, thereby allowing development of overcharge and resulting in the NG estimation in the overcharge test (see experimental examples 2 and 3). In view of this, the lithium carbonate content is preferable equal to or more than 0.5 mass %.

Table 1 also shows that experimental example 6, which contains 2.0 mass % of lithium carbonate, has a high rate discharge characteristic of 80.6%, which is a significantly degraded value compared with the 99.6%, 100.6%, 99.8%, and 99.1% high rate discharge characteristics of experimental examples 1, 2, 4, and 5.

A possible explanation for the results is as follows. Because lithium carbonate is not a contributory substance to charge and discharge, excessive addition of it inhibits the charge/discharge reactions, resulting in degradation of high rate discharge characteristic. In view of this, the lithium carbonate content is preferable equal to or less than 1.5 mass %.

### EXAMPLES

The present invention will be described on the basis of examples and comparative examples.

### Example 1

A non-aqueous electrolyte secondary cell according to example 1 was prepared in the same manner as in experimental example 1 except that in the preparation of the non-aqueous electrolyte, the electrolytic solution was 97.5 mass parts and cyclohexyl benzene (CHB) was 0.5 mass parts.

### Example 2

A non-aqueous electrolyte secondary cell according to example 2 was prepared in the same manner as in example 1 except that the electrolytic solution was 97 mass parts and CHB was 1.0 mass part.

### Example 3

A non-aqueous electrolyte secondary cell according to example 3 was prepared in the same manner as in example 1 except that the electrolytic solution was 96.5 mass parts and CHB was 1.5 mass parts.

### Example 4

A non-aqueous electrolyte secondary cell according to example 4 was prepared in the same manner as in example 1 except that the electrolytic solution was 96 mass parts and CHB was 2.0 mass parts.

### Example 5

A non-aqueous electrolyte secondary cell according to example 5 was prepared in the same manner as in example 1 except that tert-amyl benzene (TAB) was used instead of CHB.

### Example 6

A non-aqueous electrolyte secondary cell according to example 6 was prepared in the same manner as in example 2 except that tert-amyl benzene (TAB) was used instead of CHB.

### Example 7

A non-aqueous electrolyte secondary cell according to example 7 was prepared in the same manner as in example 3 except that TAB was used instead of CHB.

### Example 8

A non-aqueous electrolyte secondary cell according to example 8 was prepared in the same manner as in example 4 except that TAB was used instead of CHB.

### Comparative Example 1

A non-aqueous electrolyte secondary cell according to comparative example 1 was prepared in the same manner as in example 1.

### Comparative Example 2

A non-aqueous electrolyte secondary cell according to comparative example 2 was prepared in the same manner as in example 1 except that the electrolytic solution was 95.0 mass parts and CHB was 3.0 mass parts.

### Comparative Example 3

A non-aqueous electrolyte secondary cell according to comparative example 3 was prepared in the same manner as in comparative example 2 except that TAB was used instead of CHB.

[High-Temperature Cycle Characteristic Test]

The cells according to examples 1 to 8 and comparative examples 1 to 3 were charged at a constant current of 1 It (1200 mA) to a voltage of 4.2 V, then at a constant voltage of 4.2 V to a current of 60 mA (25° C.). Each cell was discharged at a current of 10 A to a voltage of 2.5 V to measure the discharge capacity of each cell (60° C.). This charge/discharge cycle was repeated 501 times to calculate an n-th cycle capacity retention from the following formula. The results are shown in Table 2.

N-th Cycle Capacity Retention (%)=N-th Cycle Discharge Capacity/1st Cycle Discharge Capacity×100

[Low-Temperature Discharge Characteristic Test]

The cells according to examples 1 to 4 and comparative examples 1 and 2 were charged at a constant current of 1 It (1200 mA) to a voltage of 4.2 V, then at a constant voltage of 4.2 V to a current of 60 mA (25° C.). Each cell was discharged at a current of 10 A to a voltage of 2.5 V to measure the discharge capacity of each cell (−10° C.). The average discharge voltage and the initial discharge voltage of each cell discharge were measured. The results are shown in Table 2.

TABLE 2

| | | | 101st | 201st | 301st | 401st | 501st | |
|---|---|---|---|---|---|---|---|---|
| | | | cycle | cycle | cycle | cycle | cycle | Low-temperature |
| | | Concentration | capacity | capacity | capacity | capacity | capacity | discharge test |
| | | of additives | retention | retention | retention | retention | retention | results (V) |
| | Additives | (mass %) | (%) | (%) | (%) | (%) | (%) | Average (initial) |
| Comparative | — | 0.0 | 91.8 | 83.5 | 74.5 | 69.8 | 48.6 | 3.17 (3.03) |
| example 1 | | | | | | | | |
| Example 1 | CHB | 0.5 | 93.4 | 87.7 | 82.7 | 77.4 | 72.3 | 3.17 (3.02) |
| Example 2 | | 1.0 | 93.3 | 87.5 | 83.0 | 78.9 | 76.8 | 3.16 (3.03) |
| Example 3 | | 1.5 | 93.0 | 86.6 | 83.5 | 77.5 | 72.0 | 3.17 (3.02) |
| Example 4 | | 2.0 | 91.9 | 85.4 | 78.8 | 74.2 | 63.5 | 3.16 (3.03) |
| Comparative | | 3.0 | 88.7 | 78.9 | 65.9 | 47.8 | 25.7 | 3.10 (2.94) |
| example 2 | | | | | | | | |
| Example 5 | TAB | 0.5 | 93.5 | 86.8 | 81.0 | 77.0 | 74.0 | — |
| Example 6 | | 1.0 | 93.0 | 87.7 | 82.1 | 77.0 | 72.4 | — |
| Example 7 | | 1.5 | 94.2 | 89.7 | 85.1 | 80.6 | 76.0 | — |
| Example 8 | | 2.0 | 93.1 | 86.6 | 79.0 | 73.3 | 70.2 | — |
| Comparative | | 3.0 | 89.9 | 79.9 | 70.5 | 50.2 | 35.4 | — |
| example 3 | | | | | | | | |

Table 2 shows that comparative example 1, which contains no additives, has a 501st cycle capacity retention of 48.6%, which is a significantly degraded value compared with 72.3%, 76.8%, 72.0%, 63.5%, 74.0%, 72.4%, 76.0%, and 70.2% for the 501st cycle capacity retentions of examples 1 to 8, which contain additives (CHB, TAB) at 0.5 to 2.0 mass %.

Table 2 also shows that comparative examples 2 and 3, which contain additives (CHB, TAB) at 3.0 mass %, have 501st cycle capacity retentions of 25.7% and 35.4%, respectively, which are significantly degraded values compared with 72.3%, 76.8%, 72.0%, 63.5%, 74.0%, 72.4%, 76.0%, and 70.2% for the 501st cycle capacity retentions of examples 1 to 8, which contain additives (CHB, TAB) at 0.5 to 2.0 mass %.

A possible explanation for the results is as follows. The lithium carbonate contained in the positive electrode causes a decrease in high-temperature cycle characteristic (see comparative example 1). Addition of cyclohexyl benzene (CHB) or tert-amyl benzene (TAB) to the non-aqueous electrolyte inhibits the decrease in high-temperature cycle characteristic caused by the lithium carbonate, thereby improving the high-temperature cycle characteristic (see examples 1 to 8). However, if these additives are contained at equal to or more than 3.0 mass %, they serve to inhibit the charge/discharge reactions, thereby degrading the high-temperature cycle characteristic (see comparative examples 2 and 3). In view of this, the content of cyclohexyl benzene and the content of tert-amyl benzene are preferably 0.5 to 2.0 mass %.

Table 2 also shows that comparative example 2, which contains 3.0 mass % of cyclohexyl benzene (CHB), has an average discharge voltage of 3.10 V and an initial discharge voltage of 2.94 V in the low-temperature discharge characteristic test, which are degraded values compared with the 3.16 and 3.17 average discharge voltages and the 3.02 and 3.03 initial discharge voltages for examples 1 to 4 and comparative example 1, which contain cyclohexyl benzene at 0.5 mass %, 1.0 mass %, 1.5 mass %, 2.0 mass %, and 0 mass %, respectively. The possible explanation provided above is believed to apply here.

(Supplementary Remarks)

As the positive electrode active material, manganese lithium oxide (LiMnO₂) in the form of a layer, cobalt lithium oxide (LiCoO₂), nickel lithium oxide (LiNiO₂), nickel cobalt lithium oxide (LiNiₓCo₁₋ₓO₂), nickel manganese lithium oxide (LiNiₓMn₁₋ₓO₂), and lithium iron oxide (LiFeO₂) may be used alone or in combination of two or more of the foregoing. In particular, those used in the above examples are preferred for their superiority in high rate discharge.

As the negative electrode material, in place of the above-described materials used in the examples, a carbonaceous matter, a lithium alloy, metal lithium, and a metal oxide capable of intercalating and disintercalating lithium ions may be used alone or in combination of two or more of the foregoing.

As the non-aqueous solvent, in place of the above-described materials used in the examples, butylene carbonate, γ-butyrolactone, γ-valerolactone, diethyl carbonate, sulfolan, ethyl acetate, tetrahydrofuran, 1,2-dimethoxy ethane, 1,3-dioxolane, 2-methoxy tetrahydrofuran, and diethyl ether may be used alone or in combination of two or more of the foregoing.

As the electrolytic salt, LiN(C₂F₅SO₂)₂, LiN(CF₃SO₂)₂, LiClO₄, and LiBF₄, instead of LiPF₆, may be used alone or in combination of equal to or more than two of the foregoing.

It is also possible to add both cyclohexyl benzene and tert-amyl benzene. In this case, the total content of cyclohexyl benzene and tert-amyl benzene is 0.5 to 2 mass %.

It should be noted that while vinylene carbonate is not an essential constituent of the present invention, vinylene carbonate reacts with the negative electrode to form a stable covering film, thereby proving the effect of inhibiting the reaction between the negative electrode and the non-aqueous electrolyte. In view of this, vinylene carbonate is preferably contained at 0.1 to 5 mass %, more preferably at 1 to 3 mass %.

### INDUSTRIAL APPLICABILITY

As has been described above, the present invention provides a non-aqueous electrolyte secondary cell superior in safety against overcharge and in high-temperature cycle characteristic. Thus, the industrial applicability of the present invention is significant.

What is claimed is:

1. A non-aqueous electrolyte secondary cell comprising:
a positive electrode having a positive mix having a positive electrode active material capable of intercalating and deintercalating lithium;
a negative electrode having a negative electrode active material capable of intercalating and deintercalating lithium; and
a non-aqueous electrolyte, wherein:
the positive mix contains lithium carbonate at 0.5 to 1.5 mass % relative to 100 for the total mass of the positive mix; and
the non-aqueous electrolyte contains a cycloalkyl benzene compound and/or a compound having a benzene ring and a quaternary carbon adjacent to the benzene ring, the compound or compounds being contained at 0.5 to 2 mass % in total relative to 100 for the total mass of the non-aqueous electrolyte.

2. The non-aqueous electrolyte secondary cell according to claim 1, wherein the non-aqueous electrolyte contains cyclohexyl benzene as the cycloalkyl benzene compound.

3. The non-aqueous electrolyte secondary cell according to claim 1, wherein the non-aqueous electrolyte contains tert-amyl benzene as the compound having a benzene ring and a quaternary carbon adjacent to the benzene ring.

4. The non-aqueous electrolyte secondary cell according to claim 1, wherein non-aqueous electrolyte contains the cycloalkyl benzene compound and tert-amyl benzene.

5. The non-aqueous electrolyte secondary cell according to claim 1, wherein the non-aqueous electrolyte further contains vinylene carbonate at 0.1 to 5 mass % relative to 100 for the total mass of the non-aqueous electrolyte.

6. The non-aqueous electrolyte secondary cell according to claim 1, wherein the positive electrode active material is a mixture of lithium nickel-cobalt-manganese oxide and spinel-type lithium manganese oxide.

7. The non-aqueous electrolyte secondary cell according to claim 1, further comprising a pressure sensitive safety mechanism.

8. The non-aqueous electrolyte secondary cell according to claim 7, wherein the non-aqueous electrolyte contains cyclohexyl benzene as the cycloalkyl benzene compound.

9. The non-aqueous electrolyte secondary cell according to claim 7, wherein the non-aqueous electrolyte contains tert-amyl benzene as the compound having a benzene ring and a quaternary carbon adjacent to the benzene ring.

10. The non-aqueous electrolyte secondary cell according to claim 7, wherein non-aqueous electrolyte contains the cycloalkyl benzene compound and tert-amyl benzene.

11. The non-aqueous electrolyte secondary cell according to claim 7, wherein the non-aqueous electrolyte further contains vinylene carbonate at 0.1 to 5 mass % relative to 100 for the total mass of the non-aqueous electrolyte.

12. The non-aqueous electrolyte secondary cell according to claim 7, wherein the positive electrode active material is a mixture of lithium nickel-cobalt-manganese oxide and spinel-type lithium manganese oxide.
